(19) United States
(12) Patent Application Publication
(10) Pub. No.: US 2024/0384189 A1
(43) Pub. Date: Nov. 21, 2024

(54) METHOD FOR CONDUCTING HIGH-TEMPERATURE THERMOLYSIS OF WASTE TIRES AND RUBBER PRODUCTS

(71) Applicant: IFALLIANCEUSA LLC, New York, NY (US)

(72) Inventor: Farhad MAMMADOV, BRICK, NJ (US)

(21) Appl. No.: 18/198,930

(22) Filed: May 18, 2023

(51) Int. Cl. C10J 3/82; B03B 9/06; B03C 1/30; C01B 32/05; C10B 47/32; C10B 53/07; C10B 57/10

(52) U.S. Cl. CPC C10J 3/82; B03B 9/06; B03C 1/30; C01B 32/05; C10B 47/32; C10B 53/07; C10B 57/10; B03C 2201/20; C10J 2300/0906; C10J 2300/0946; C10J 2300/1625

(57) ABSTRACT

A method for conducting high-temperature thermolysis of waste tires and rubber products are proposed. By using the method, the waste tires and rubber products may be recycled jointly and efficiently to produce hard carbon, a synthesis gas, and a thermolysis liquid, which may be used profitably for various purposes.

### TECHNICAL FIELD

The present disclosure relates generally to the field of thermal destruction of solid industrial wastes. In particular, the present disclosure relates to a method for conducting high-temperature thermolysis of waste tires and rubber products to obtain a synthesis gas, hard carbon, and a thermolysis liquid.

### BACKGROUND

The rapid growth of a car fleet observed over the past decade has become a natural reason for the exacerbation of the problem of accumulation and recycling of waste tires and rubber products. This problem is getting worse every year. The waste tires and rubber products belong to the most dangerous group of waste that is not biodegradable. The waste tires and rubber products cannot be used for their intended purpose, and, therefore, are industrial waste to be recycled, and are also a fuel-energy carrier.

Thus, there is a need for a technical solution that ensures high-quality recycling of the waste tires and rubber products with the production of a synthesis gas, carbon black and a thermolysis liquid, which are subject to further beneficial use.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that ensures high-quality recycling of waste tires and rubber products by high-temperature thermolysis.

The objective above is achieved by the features of the independent claim in the appended claims. Further embodiments and examples are apparent from the dependent claims, the detailed description, and the accompanying drawings.

According to an aspect, a method for conducting high-temperature thermolysis of waste tires and rubber products is provided. The method starts with the step of grinding the waste tires and the rubber products to coarse fractions by using a coarse grinding unit. Then, the method proceeds to the step of washing the coarse fractions in a washing unit. Next, the method goes on to the step of grinding the washed coarse fractions to fine fractions by using a fine grinding unit. The fine fractions comprise rubber granules, metal cord elements and fabric cord elements. After that, the method proceeds to the step of using a magnetic separator to separate the metal cord elements from the fine fractions. The method further goes on to the step of storing the separated metal cord elements in a storage of metal cord elements. Subsequently, the method proceeds to the steps of using a first cyclonic separator to separate the rubber granules and the fabric cord elements from the fine fractions and storing the separated rubber granules in a storage of rubber granules. Next, the method goes on to the steps of using a first fine filter to purify the separated fabric cord elements from fine mechanical impurities and storing the purified fabric cord elements in a storage of fabric cord elements. Further, the method proceeds to the steps of transferring a given amount of the rubber granules from the storage of rubber granules to a storage hopper first and then to an agitator hopper. After that, the method goes on to the step of using a metering hopper to perform a metered supply of the rubber granules from the agitator hopper to the screw-conveyor dryer, while replacing ambient air with carbon dioxide (CO2). Next, the method proceeds to the step of heating and dehumidifying the rubber granules in the screw-conveyor dryer. Then, the method goes on to the step of obtaining a pulverized mixture by conducting the high-temperature thermolysis of the heated and dehumidified rubber granules in a striker mill. The pulverized mixture comprises a solid fraction and a gas-vapor fraction. The solid fraction comprises coarse-grained hard carbon and fine-grained hard carbon. The method further proceeds to the steps of using a second cyclonic separator to separate the coarse-grained hard carbon from the solid fraction of the pulverized mixture and using a first cooling screw-conveyor to cool and transport the separated coarse-grained hard carbon to a storage of coarse-grained hard carbon. After that, the method goes on to the steps of using a third cyclonic separator to separate the fine-grained hard carbon from the solid fraction of the pulverized mixture and using a second cooling screw-conveyor to cool and transport the separated fine-grained hard carbon to a storage of fine-grained hard carbon. Next, the method proceeds to the steps of obtaining a thermolysis liquid and a synthesis gas by cooling and condensing the gas-vapor fraction of the pulverized mixture in a refrigerator-type condenser and storing the thermolysis liquid in a thermolysis liquid storage. Further, the method goes on to the steps of using a coarse filter to purify the synthesis gas from coarse mechanical impurities and using a pump to supply the synthesis gas from the coarse filter to a first synthesis gas storage, while increasing a pressure of the synthesis gas to 1 bar. Then, the method proceeds to the step of using a gas compressor to pump over the synthesis gas from the first synthesis gas storage to a second synthesis gas storage, while increasing the pressure of the synthesis gas up to 10 bar. After that, the method goes on to the steps of using a second fine filter to purify the synthesis gas from the second synthesis gas storage from fine mechanical impurities and storing the purified synthesis gas under the overpressure up to 10 bar in a third synthesis gas storage.

By using the method, any waste tires and any rubber products (especially rubber technical products, such as nylon, PVC, latex, etc.) may be recycled jointly and efficiently to produce hard carbon, a synthesis gas, and a thermolysis liquid, which may be used profitably for various purposes.

In one exemplary embodiment, each of the coarse fractions has a size ranging from 200 to 300 mm, and each of the fine fractions has a size ranging from 1 to 6 mm. The coarse and fine fractions having such sizes may be further processed more efficiently, thereby providing better execution of the method.

In one exemplary embodiment, the rubber granules are heated to a temperature of 300-350° C. and dehumidified to a humidity of 2-3% in the screw-conveyor dryer. The rubber granules thus heated and dehumidified may be further processed in the striker mill more efficiently, thereby providing better execution of the method.

In one exemplary embodiment, the high-temperature thermolysis of the heated and dehumidified rubber granules is conducted in the striker mill at a temperature of 760-810° C. By using these temperatures, the high-temperature thermolysis of the rubber granules may be conducted more efficiently, thereby resulting in products having high consumer properties (i.e., the resulting pulverized mixture may have better properties, such as a higher calorific value of the resulting synthesis gas, a more qualitative composition of the thermolysis liquid, etc.).

In one exemplary embodiment, the separated coarse-grained hard carbon has a grain size ranging from 0.5 to 0.7 mm and is cooled by the first cooling screw-conveyor to a temperature of 20-50° C., while the separated fine-grained hard carbon has a grain size ranging from 0.1 to 0.49 mm and is cooled by the second cooling screw-conveyor to a temperature of 20-50° C. Such grain sizes of the coarse-grained and fine-grained solid carbon may be more convenient for storage and further use.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a block diagram of a system for conducting high-temperature thermolysis of waste tires and rubber products in accordance with one exemplary embodiment;

FIG. 2 shows a front view of a metering hopper included in the system of FIG. 1 in accordance with one exemplary embodiment;

FIG. 3 shows a front view of a screw-conveyor dryer included in the system of FIG. 1 in accordance with one exemplary embodiment;

FIG. 4 shows a sectional front view of a striker mill included in the system of FIG. 1 in accordance with one exemplary embodiment; and

FIGS. 5A-5D show a flowchart of a method for operating the system of FIG. 1 in accordance with one exemplary embodiment.

### DETAILED DESCRIPTION

Various embodiments of the present disclosure are further described in more detail with reference to the accompanying drawings. However, the present disclosure may be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the system and method disclosed herein may be implemented in practice by using any numbers of the embodiments provided herein. Furthermore, it should be understood that any embodiment of the present disclosure may be implemented using one or more of the features presented in the appended claims.

The word “exemplary” is used herein in the meaning of “used as an illustration”. Unless otherwise stated, any embodiment described herein as “exemplary” should not be construed as preferable or having an advantage over other embodiments.

Any positioning terminology, such as “left”, “right”, “top”, “bottom”, “above” “below”, “upper”, “lower”, “horizontal”, “vertical”, “front”, “rear”, etc., may be used herein for convenience to describe one element's or feature's relationship to one or more other elements or features in accordance with the figures. It should be apparent that the positioning terminology is intended to encompass different orientations of the devices or units used to implement the method disclosed herein, in addition to the orientation(s) depicted in the figures. As an example, if one imaginatively rotates the apparatus in the FIGS. 90 degrees clockwise, elements or features described as “left” and “right” relative to other elements or features would then be oriented, respectively, “above” and “below” the other elements or features. Therefore, the positioning terminology used herein should not be construed as any limitation of the invention.

Although the numerative terminology, such as “first”, “second”, etc., may be used herein to describe various embodiments, elements or features, these embodiments, elements or features should not be limited by this numerative terminology. This numerative terminology is used herein only to distinguish one embodiment, element or feature from another embodiment, element or feature. For example, a first synthesis gas storage may be called a second synthesis gas storage, and vice versa, without departing from the teachings of the present disclosure.

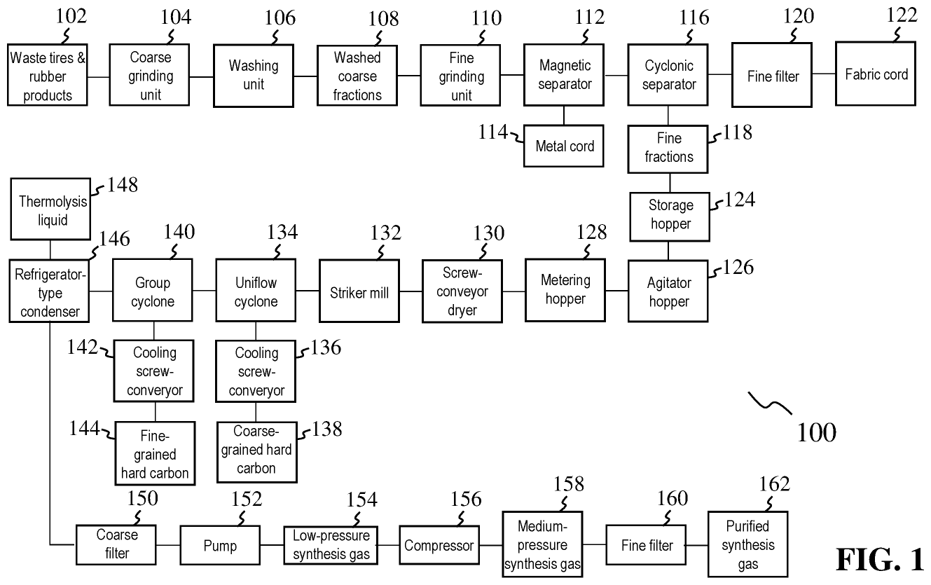

FIG. 1 shows a block diagram of a system 100 for conducting high-temperature thermolysis of waste tires and rubber products in accordance with one exemplary embodiment. The system 100 comprises the following constructive elements: a first storage 102, a coarse grinding unit 104, a washing unit 106, a second storage 108, a fine grinding unit 110, a magnetic separator 112, a third storage 114, a first cyclonic separator 116, a fourth storage 118, a first fine filter 120, a fifth storage 122, a storage hopper 124, an agitator hopper 126, a metering hopper 128, a screw-conveyor dryer 130, a striker mill 132, a second cyclonic separator 134, a first cooling screw-conveyor 136, a sixth storage 138, a third cyclonic separator 140, a second cooling screw-conveyor 142, a seventh storage 144, a refrigerator-type condenser 146, an eighth storage 148, a coarse filter 150, a pump 152, a first synthesis gas storage 154, a gas compressor 156, a second synthesis gas storage 158, a second fine filter 160, and a third synthesis gas storage 162. Each of the constructive elements of the system 100 will be described in detail below.

The first storage 102 is configured to receive and store the waste tires and the rubber products. In the exemplary embodiments disclosed herein, the rubber products may refer to intermediate and/or finished products manufactured using rubber compounds for manufacturers and consumers. The storage 102 for the waste tires and rubber products may be a production facility containing a floor, vertical walls and a roof, which in concert form the boundary of a cavity in which the tires and rubber products may be placed and stored. The shape and dimensions of the storage 102 should be such that vehicles loaded with the tires and rubber products can move into the cavity. The cavity may comprise all necessary equipment for placing and storing the waste tires and rubber products, as well as for their subsequent removal from the cavity.

The coarse grinding unit 104 is coupled to the first storage 102 and configured to grind the waste tires and the rubber products to coarse fractions. The coarse grinding unit 104 may be a shredder comprising a frame on which an electric drive, a charging unit, working grinding bodies configured as shafts having cutting elements and connected to the electric drive are mounted. The coarse grinding unit 104 (e.g., the shredder) is configured to provide the mechanical destruction of the waste tires and rubber products into separate coarse (i.e., large) fractions or fragments having an average size of 200-300 mm. The presence of the coarse grinding unit 104 is predetermined by the significant circumstance that the grinding of the waste tires and rubber products is carried out in two stages, where coarse fractions or fragments are obtained in the first stage, and the coarse fractions are then grinded (by the fine grinding unit 110) to fine (i.e., small) fractions in the second stage.

The washing unit 106 is coupled to the coarse grinding unit 104 and configured to wash the coarse fractions. The washing unit 106 comprises a bath with a washing solution, a charging unit, a washing solution supply unit, and a discharging unit. The charging unit is formed by the descending section of a scraper conveyor, while the discharging unit is formed by the ascending section of the scraper conveyor. The scraper conveyor also comprises a middle horizontal section that is arranged between the descending and ascending sections of the scraper conveyor and immersed in the washing solution. The washing solution supply unit is configured to supply the washing solution under excessive pressure to the coarse fractions of the waste tires and rubber products, which are located on the middle horizontal section of the scraper conveyor and moved together with the latter.

The second storage 108 is coupled to the washing unit 106 and configured to receive and store the washed coarse fractions. The second storage 108 includes a container having a wall and an open cavity, a discharging unit formed by an electrically driven conveyor.

The fine grinding unit 110 is coupled to the second storage 108 and configured to grind the washed coarse fractions to fine fractions. The fine fractions comprise, among others, rubber granules, metal cord elements and fabric cord elements. Each of the rubber granules may be 1-6 mm in size. The fine grinding unit 110 may be a shredder comprising a frame on which an electric drive, a charging unit, working grinding bodies configured as shafts having cutting elements connected to the electric drive are mounted. The fine grinding unit 110 (e.g., the shredder) is configured to provide the mechanical destruction of the coarse fractions of the waste tires and rubber products into the fine fractions. The presence of the fine grinding unit 110 is predetermined by the need to obtain the rubber granules with a particle size of 1-6 mm, necessary for further processing.

The magnetic separator 112 is coupled to the fine grinding unit 110 and configured to separate the metal (e.g., steel) cord elements from the fine fractions. This separation is caused by the fact that the metal cord elements made of steel have ferromagnetic properties. The magnetic separator 112 may be of a rod type with automatic cleaning, or of any other type. In general, the type of the magnetic separator 112 is not essential, since the function of separating the metal cord elements from the fine fractions can be implemented with any type of the magnetic separator. The rod-type magnetic separator with automatic cleaning comprises magnetic rods based on powerful magnets made of a rare earth alloy, placed in a housing made in the form of a pipeline section. The housing of the magnetic separator is sealed, and the inlet and outlet of the magnetic separator can be made in the form of connecting flanges. Passing through the magnetic separator 112, the flow of the processed material (i.e., the fine fractions of the waste tires and rubber products) enters a powerful magnetic field, under the influence of which ferromagnetic inclusions (i.e., the metal cord elements) linger on the surface of the rods, while the fabric cord elements and the rubber granules move on.

The third storage 114 is coupled to the magnetic separator 112 and configured to receive and store the metal cord elements. The third storage 114 includes a container having a wall and an open cavity, as well as a charging unit and a discharging unit which are provided with electrically driven conveyors. The presence of the third storage 114 is predetermined by the need to place and subsequently store the metal cord elements.

The first cyclonic separator 116 is coupled to the magnetic separator 112 and configured to separate the rubber granules and the fabric cord elements from the fine fractions. The first cyclonic separator 116 is configured to isolate the rubber granules and the fabric cord elements from the remaining flow of the fine fractions coming from the magnetic separator 112. The first cyclonic separator 116 may be implemented as a group cyclone that comprises individual cyclones connected to each other in a group, and each individual cyclone of the group comprises a hollow steel body connected to an inlet pipe, an upper outlet pipe and a lower outlet pipe. The inlet pipe is in communication with the flow of the fine fractions from the metal separator 112, the upper outlet pipe serves to remove the fabric cord elements, and the lower outlet pipe serves to remove the rubber granules.

The fourth storage 118 is coupled to the first cyclonic separator 116 and configured to receive and store the rubber granules. The fourth storage 118 includes a container having a wall and an open cavity, as well as a charging unit and a discharging unit which are provided with electrically driven conveyors. The presence of the fourth storage 118 is predetermined by the need to place and subsequently store the rubber granules.

The first fine filter 120 is coupled to the first cyclonic separator 116 and configured to purify the fabric cord elements from fine mechanical impurities. The filter 120 includes a hollow body, a filter element, an inlet pipe, an outlet pipe, and a unit for removing the fabric cord elements from the surface of the filter element. The filter element ensures the separation of the fabric cord elements from the flow supplied under excess pressure from the first cyclonic separator 116. The inlet pipe provides the supply of this flow containing the fabric cord elements and the fine mechanical impurities into the cavity of the filter body and onto the filter element. The outlet pipe ensures the removal of the purified flow from the cavity of the filter body. The unit for removing the fabric cord elements from the surface of the filter element ensures the removal of the fabric cord elements outside the filter. The presence of the filter 120 is predetermined by the need to separate the fabric cord elements from the mechanical impurities present in the flow of the processed material coming from the first cyclonic separator 116.

The fifth storage 122 is coupled to the first fine filter 120 and configured to receive and store the purified fabric cord elements. The fifth storage 122 includes a container having a wall and an open cavity, as well as a charging unit and a discharging unit which are provided with electrically driven conveyors.

The storage hopper 124 is configured to periodically receive the rubber granules from the fourth storage 118 in a given amount and subsequently store the rubber granules. More specifically, the storage hopper 124 provides for the placement and subsequent storage of the rubber granules in the amount necessary for one production shift. The storage hopper 124 includes a container having a wall and an open cavity, and a discharging unit comprising an electrically driven conveyor. The presence of the storage hopper 124 is predetermined by the need to place and subsequently store the rubber granules in the amount necessary for one production shift. The volume of the open cavity of the storage hopper 124 is significantly less than the volume of the open cavity of the fourth storage 118.

The agitator hopper 126 is coupled to the storage hopper 124 and configured to receive and store the rubber granules while constantly agitating or mixing the rubber granules (the latter is necessary to prevent the formation of rubber granule aggregates immediately before it is fed into the metering hopper 128). The agitator hopper 126 includes a container having a wall and a cavity, an electric agitating unit, and a discharging unit containing an electrically driven screw-conveyor. The presence of the agitator hopper 126 is predetermined by the need to place, store, and agitate or mix the rubber granules.

The metering hopper 128 is arranged between the agitator hopper 126 and the screw-conveyor dryer 130. The metering hopper 128 is configured to perform a metered supply of the rubber granules from the agitator hopper 126 to the screw-conveyor dryer 130, while replacing ambient air with carbon dioxide (CO2). Carbon dioxide is necessary to create an inert environment that excludes oxidative processes that occur using oxygen from the ambient air.

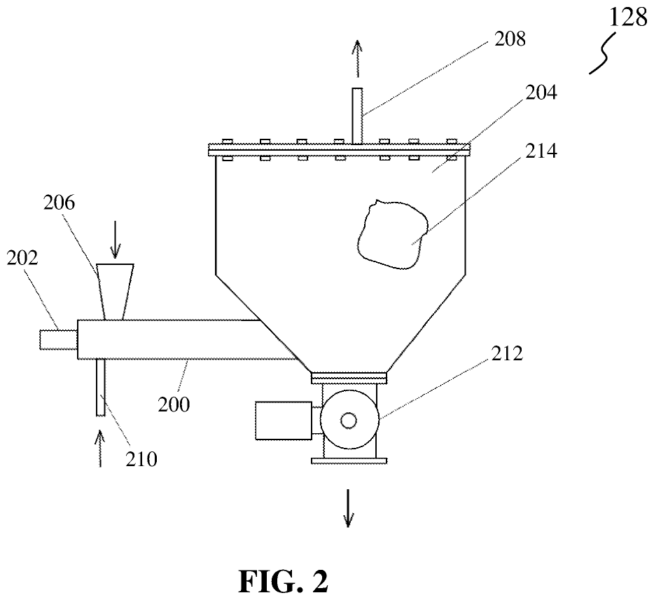

FIG. 2 shows a front view of the metering hopper 128 included in the system 100 in accordance with one exemplary embodiment. As shown in FIG. 2, the metering hopper 128 comprises a screw conveyor 200, an electric drive 202, a working chamber 204, a charging cone 206, an air outlet nozzle 208, a carbon dioxide inlet nozzle 210, and an electric sliding gate 212. The screw conveyor 200 has a first (left) end and a second (right) end, and the electric drive 202 (e.g., a gear-motor drive) is coupled to the first end of the screw conveyor 200 (i.e., to its working body) to drive it. The working chamber 204 is coupled to the second end of the screw conveyor 200 and has an inner cavity 214. The charging cone 206 is attached to the screw conveyor 200 near the first end of the screw conveyor 200 and communicates with the transport cavity of the screw conveyor 200. The air outlet nozzle 208 is attached to the working chamber 204 (i.e., to its upper section) and communicates with the inner cavity 214. The carbon dioxide inlet nozzle 210 is attached to the screw conveyor 200 near the first end of the screw conveyor 200 (i.e., under the charging cone 206) and communicates with the transport cavity of the screw conveyor 200. Thus, the screw conveyor 200 may provide the supply of the waste mixture from the mixer 106 and CO2 into the inner cavity 214 of the working chamber 204. The electric sliding gate 212 is attached to the working chamber 204 from below. The electric sliding gate 212 is configured to cause the rubber granules to move from the inner cavity 214 to the screw-conveyor dryer 130. The metering hopper 128 thus configured provides the metered or dosed supply of the rubber granules to the screw-conveyor dryer 130, as well as ensures the displacement of environmental air and its replacement with CO2 directly at the inlet to the screw-conveyor dryer 130.

The screw-conveyor dryer 130 is coupled to the metering hopper 128. The screw-conveyor dryer 130 is configured to heat and dehumidify the rubber granules coming from the metering hopper 128. For example, the screw-conveyor dryer 130 may heat the rubber granules to a temperature of 300-350° C. and reduce the humidity of the rubber granules to 2-3%.

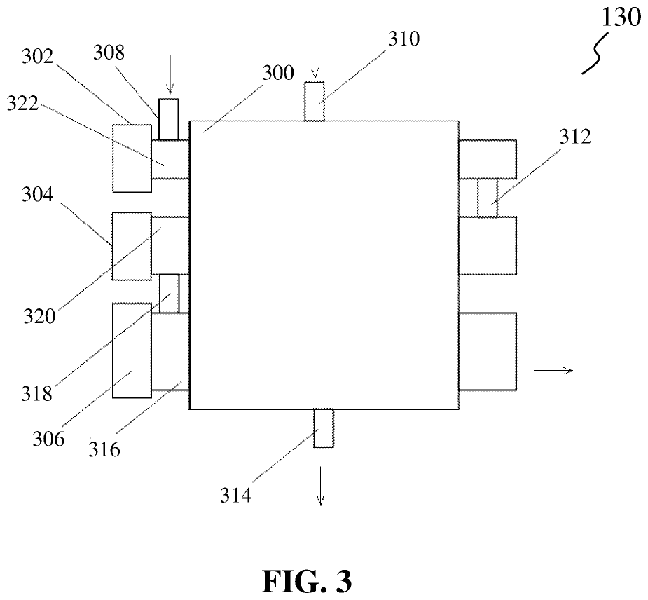

FIG. 3 shows a front view of the screw-conveyor dryer 130 included in the system 100 in accordance with one exemplary embodiment. The screw-conveyor dryer 130 comprises a hollow body 300, a top electric drive 302, a middle electric drive 304, a bottom electric drive 306, and a charging hopper 308. The hollow body 300 comprises an inlet nozzle 310, a top coupling pipe 312, an outlet nozzle 314, a bottom tube 316, a bottom coupling pipe 318, a middle tube 320, and a top tube 322. Each of the bottom tube 316, the middle tube 320 and the top tube 322 has a screw conveyor arranged therein. The top electric drive 302 is coupled to the screw conveyor (i.e., its working body) in the top tube 322. The middle electric drive 304 is coupled to the screw conveyor (i.e., its working body) in the middle tube 320. The bottom electric drive 306 is coupled to the screw conveyor (i.e., its working body) in the bottom tube 316. The charging hopper 308 is attached to the top tube 322 and configured to receive the rubber granules from the metering hopper 108. The inlet nozzle 310 is coupled to a system for supplying a gaseous heat-conducting medium to the cavity of the hollow body 300. The outlet nozzle 314 is coupled to a system for removing the gaseous heat-conducting medium from the cavity of the hollow body 300.

The middle sections of the top tube 322, the middle tube 320 and the bottom tube 316 are arranged in the cavity of the hollow body 300 and are in contact with the gaseous heat-conducting medium, while the end sections of the top tube 322, the middle tube 320 and the bottom tube 316 are arranged outside the hollow body 300. The top coupling pipe 312 is configured to connect the top tube 322 and the middle tube 320. The bottom coupling pipe 318 is configured to connect the middle tube 320 and the bottom tube 316.

The middle tube 320 is larger than the top tube 322 in diameter but smaller than the bottom tube 316 in diameter. From this circumstance, it follows that with equal productivity of these three sections, the revolutions of the screw conveyor arranged in the through cavity of the middle tube 320 are less than the revolutions of the screw conveyor arranged in the through cavity of the top tube 322, but greater than the revolutions of the screw conveyor arranged in the through cavity of the bottom tube 316. It is these ratios that have a positive effect on the time the transported rubber granules stay in heat transfer zones (this is required to ensure that the rubber granules are evenly heated to a desired temperature), as well as on the quality of the transported rubber granules in terms of preventing the rubber granules from sticking to the contact surfaces.

During the operation of the screw-conveyor dryer 130, thermal energy from the gaseous heat-conducting medium is transferred to the middle sections of the top tube 322, the middle tube 320 and the bottom tube 316, and then to the transported rubber granules. The middle section of at least one of the top tube 322, the middle tube 320 and the bottom tube 316 may have holes to remove the excessive water vapor formed during drying. The heat-affected rubber granules from the screw-conveyor dryer 130 are removed from the through cavity of the bottom tube 316 by means of the screw conveyor arranged therein.

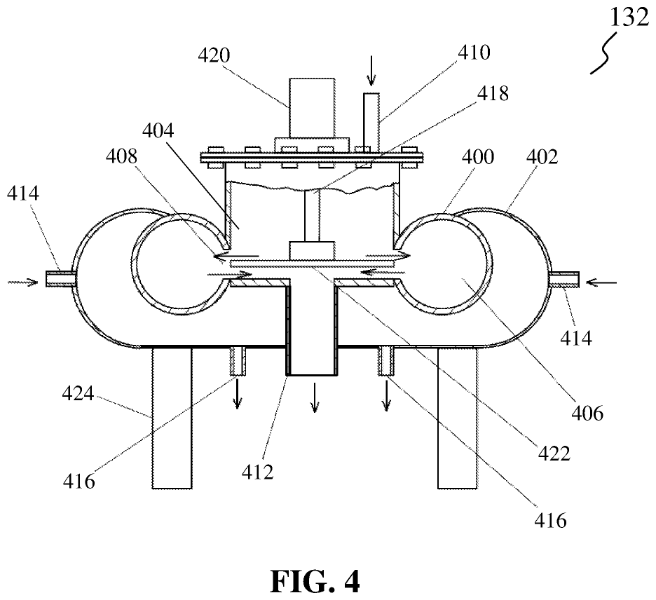

The striker mill 132 (also referred to as an impact mill in this technical filed) is coupled to the screw-conveyor dryer 130. The striker mill 132 is configured to conduct the high-temperature thermolysis of the rubber granules, grind them, and remove the products of the thermolysis (i.e., a pulverized mixture comprising a solid fraction and a gas-vapor fraction) outside the striker mill 132. The striker mill 132 provides a preliminary separation of the gas-vapor fraction from the solid fraction, which are removed from it in different directions. The striker mill 132 is a multifunctional object, and the implementation of its functions is carried out by means of a single electric drive (like the one denoted by 420 in FIG. 4). The striker mill 132 is configured to conduct the high-temperature thermolysis at a temperature of 760-810° C. Moreover, the striker mill 132 provides a reduction in the humidity of the rubber granules to 0.2-0.4%, as well as their additional grinding and subsequent removal.

FIG. 4 shows a sectional front view of the striker mill 132 included in the system 100 in accordance with one exemplary embodiment. The striker mill 132 comprises a working chamber comprising a first (inner) cavity 400 and a second (outer) cavity 402. The first cavity 400 has a cylindrical part 404 and a toroidal part 406 which are interconnected near the bottom of the cylindrical part 404 through an annular slot 408. The cylindrical part 404 has an inlet pipe 410 coupled to the screw-conveyor dryer 130 and an outlet pipe 412 coupled to the second cyclonic separator 134. The second cavity 402 surrounds the toroidal part 406 of the first cavity 400 and has two inlet nozzles 414 for a (e.g., gaseous) heat-conducting medium and two outlet nozzles 416 for the heat-conducting medium. It should be noted that the present disclosure is not limited to the numbers of the inlet and outlet nozzles 414 and 416 which are shown in FIG. 4; in other embodiments, the second cavity 402 may have a single inlet nozzle and a single outlet nozzle for the heat-conducting medium, or more than two inlet nozzles and more than two outlet nozzles for the heat-conducting medium. The striker mill 132 further comprises a vertical drive shaft 418 having a first end arranged outside the working chamber and a second end arranged inside the cylindrical part 404 of the first cavity 400. The second end of the vertical drive shaft 418 is attached to a horizontal spreading disk 422 which is aligned with the annular slot 408. The striker mill 132 further comprises an electric drive 420 coupled to the first end of the vertical drive shaft 418. The working chamber may be supported by one or more vertical posts 424.

Through the inlet pipe 410, the rubber granules are fed from the screw-conveyor dryer 130 into the cylindrical part 404 of the first cavity 400 and then to the horizontal spreading disk 422. The rubber granules are fed into the toroidal part 406 of the first cavity 400 due to the centrifugal force exerting on the rubber granules arranged on the (upper) surface of the horizontal spreading disk 422, as well as due to the fact that the vertical drive shaft 418 is attached to the horizontal spreading disk 422 aligned with the annular slot 408. The horizontal spreading disk 422 is installed relative to the annular groove 408 such that the rubber granules are fed into the toroidal part 406 of the first cavity 400 to conduct the high-temperature thermolysis (or thermal destruction) exclusively through the upper section of the annular groove 408, and the products of the high-temperature thermolysis (i.e., the pulverized mixture) are removed from the toroidal part 406 of the first cavity 400 exclusively through the lower section of the annular groove 408 and the outlet pipe 412 (this is schematically shown by means of arrows in FIG. 4). The temperature required for the high-temperature thermolysis is provided in the toroidal part 406 of the first cavity 400 by supplying the heat-conducting medium, through the inlet nozzles 414, into the second cavity 402. The heat-conducting medium is then removed from the second cavity 402 through the outlet nozzles 416.

The operational principle of the striker mill 132 is as follows.

The temperature required for the high-temperature thermolysis is provided and maintained in the second cavity 402 (including its wall) and in the toroidal part 406 (including its wall) of the first cavity 400 throughout the high-temperature thermolysis. After that, the electric drive 420 is turned on, thereby causing the vertical drive shaft 418 and, consequently, the spreading horizontal disc 422 to rotate. Then, the rubber granules are fed from the screw-conveyor dryer 130 into the cylindrical part 404 of the first cavity 400. Under the influence of the centrifugal force, the rubber granules arranged on the (upper) surface of the horizontal spreading disk 422 moves into the toroidal part 406 of the first cavity 400, hits the hot wall of the toroidal part 406, whereupon it heats up and mechanically breaks into numerous fragments, thereby leading to a significant increase in the area of the fragments of the rubber granules by 3-10 times. The concave shape of the wall of the toroidal part 406 provides numerous collisions of the fragments of the rubber granules against the wall of the toroidal part 406, as well as between themselves, which leads to their additional heating and grinding. The rotating horizontal spreading disk 422 having a circular shape supplies the rubber granules through the upper section of the annular slot 408 into the toroidal part 406 and subsequently removes the products of the high-temperature thermolysis from the toroidal part 406 of the first cavity 400 through the lower section of the annular slot 408 and the outlet pipe 412 (see the arrows in FIG. 4). As noted above, these products are represented by the pulverized mixture comprising the solid fraction and the gas-vapor fraction. The solid fraction may comprise coarse-grained hard carbon (e.g., with a grain size of 0.5 to 0.7 mm) and fine-grained hard carbon (e.g., with a grain size of 0.1 to 0.49 mm).

The second cyclonic separator 134 is coupled to the striker mill 132 and configured to separate the coarse-grained hard carbon from the pulverized mixture. The second cyclonic separator 134 has a cooling jacket and, therefore, may also provide partial cooling by removing heat energy through a liquid medium supplied to the cooling jacket of the second cyclonic separator 134. For example, the second cyclonic separator 134 may reduce the temperature of the pulverized mixture to 500-550° C. The second cyclonic separator 134 may be implemented as a uniflow cyclone that comprises a hollow steel body with a unit for supplying the pulverized mixture, a unit for swirling the supplied pulverized mixture, and a unit for separating a portion of the solid fraction from the pulverized mixture in the form of the coarse-grained hard carbon.

The first cooling screw-conveyor 136 is arranged between the second cyclonic separator 134 and the sixth storage 138. The first cooling screw-conveyor 136 is configured to transport the coarse-grained hard carbon from the second cyclonic separator 134 to the sixth storage 138, as well as to remove thermal energy from the moving coarse-grained solid carbon coming from the second cyclonic separator 134. For example, the cooling screw-conveyor 136 may cool the coarse-grained hard carbon to a temperature of 20-50° C. The cooling screw-conveyor 136 comprises a horizontal pipe having a cavity for water circulation, an electric drive, an inlet pipe, an outlet pipe, a water supply and discharge system. A hollow conveyor screw is placed in the horizontal pipe. The cavity for water circulation and the hollow conveyor screw are connected with the water supply and discharge system, which is necessary for the removal of thermal energy.

The sixth storage 138 is configured to receive and store the coarse-grained hard carbon. The sixth storage 138 comprises a hollow body formed by a vertical steel wall and a bottom in the form of a truncated cone which form a cavity boundary. An electrically driven screw conveyor is attached to the bottom of the truncated cone to remove the coarse-grained hard carbon from the hollow body.

The third cyclonic separator 140 is coupled to the second cyclonic separator 134. The third cyclonic separator 140 has a cooling jacket and is configured to separate the fine-grained hard carbon from the solid fraction of the pulverized mixture, while providing its partial cooling by removing heat energy through a liquid medium. The third cyclonic separator 140 may be implemented as a group cyclone that comprises several cyclones interconnected to form a group, which includes, for example, four cyclones. Each individual cyclone of the group comprises a hollow steel body encompassing a unit for supplying the high-temperature thermolysis products, a solid fraction removal unit, a gas-vapor mixture removal unit, a cooling jacket connected to a water supply and discharge system, which is necessary for the removal of thermal energy.

The second cooling screw-conveyor 142 is arranged between the third cyclonic separator 140 and the seventh storage 144. The second cooling screw-conveyor 142 is configured to transport the fine-grained hard carbon from the third cyclonic separator 140 to the seventh storage 144, as well as to remove thermal energy from the moving fine-grained solid carbon coming from the third cyclonic separator 140. Similarly, the cooling screw-conveyor 142 may cool the fine-grained hard carbon to a temperature of 20-50° C. The second cooling screw-conveyor 142 may be implemented in the same or similar manner as the first cooling screw-conveyor 136.

The seventh storage 144 is configured to receive and store the fine-grained hard carbon. The seventh storage 144 may be implemented in the same or similar manner as the sixth storage 138.

The refrigerator-type condenser 146 is coupled to the third cyclonic separator 140. The condenser 146 is configured to obtain a thermolysis liquid and a synthesis gas by cooling and condensing the gas-vapor fraction of the pulverized mixture. In general, the condenser 146 may be a heat exchanger in which the following processes are performed: a condensation process, and a process of phase transition of a heat-conducting medium from a gas-vapor state to a liquid state due to heat removal by using a coolant. The condenser 146 may comprise a hollow body, a vapor-gas mixture supply unit, a synthesis gas outlet unit, a thermolysis liquid outlet unit, and a condensation unit. The superheated pulverized mixture is fed from the third cyclonic separator 140 into the condenser 146, then cooled to its saturation temperature and, condensing, passes into a liquid phase with the formation of the thermolysis liquid and the synthesis gas. To condense steam, it is necessary to remove, from each unit of its mass, heat equal to a specific heat of condensation. The condenser 146 may be of water-cooled type.

The eighth storage 148 is coupled to the condenser 146 and configured to receive and store the thermolysis liquid. The eighth storage 148 may include a container having a wall and a cavity, as well as a charging unit and a discharging unit which are provided with electric drives.

The coarse filter 150 is coupled to the condenser 146 and configured to purify the synthesis gas from coarse mechanical impurities. The coarse filter 150 may include a hollow body, a filter element, an inlet pipe, an outlet pipe, a unit for removing dispersed fractions from the surface of the filter element. The filter element is configured to separate the dispersed fractions from the synthesis gas supplied under excess pressure. The inlet pipe serves to supply the synthesis gas to the hollow body and to the filter element. The outlet pipe serves to remove the purified synthesis gas from the hollow body to the outside. The presence of the coarse filter 150 is predetermined by the need to separate the dispersed fractions from the synthesis gas.

The pump 152 is arranged between the coarse filter 150 and the first synthesis gas storage 154. The pump 152 is configured to supply the synthesis gas from the coarse filter 150 to the first synthesis gas storage 154 while increasing a pressure of the synthesis gas to 1 bar.

The first synthesis gas storage 154 is configured to receive and store the purified synthesis gas under an overpressure of 1 bar. The first synthesis gas storage 154 may include a container having a wall and a cavity, as well as a charging unit and a discharging unit which are provided with electric drives.

The gas compressor 156 is arranged between the first synthesis gas storage 154 and the second synthesis gas storage 158. The gas compressor 156 is configured to pump over the synthesis gas from the first synthesis gas storage 154 to the second synthesis gas storage 158 while increasing a pressure of the synthesis gas up to 10 bar.

The second synthesis gas storage 158 is configured to receive and store the purified synthesis gas under the overpressure up to 10 bar. The second synthesis gas storage 158 may be implemented in the same or similar manner as the first synthesis gas storage 154.

The second fine filter 160 is coupled to the second synthesis gas storage 158 and configured to purify the synthesis gas from fine mechanical impurities (dispersed fractions). The second fine filter 160 may include a hollow body, a filter element, an inlet pipe, an outlet pipe, a unit for removing dispersed fractions from the surface of the filter element. The filter element is configured to separate fine dispersed fractions from the synthesis gas supplied under excess pressure. The inlet pipe serves to supply the synthesis gas to the hollow body and onto the filter element. The outlet pipe serves to remove the purified synthesis gas from the hollow body to the outside. The presence of the second fine filter 160 is predetermined by the need to separate the fine dispersed fractions from the synthesis gas.

The third synthesis gas storage 162 is coupled to the second fine filter 160 and configured to receive and store the purified synthesis gas under overpressure up to 10 bar. The third synthesis gas storage 162 may be implemented in the same or similar manner as the first and second synthesis gas storages 154 and 158.

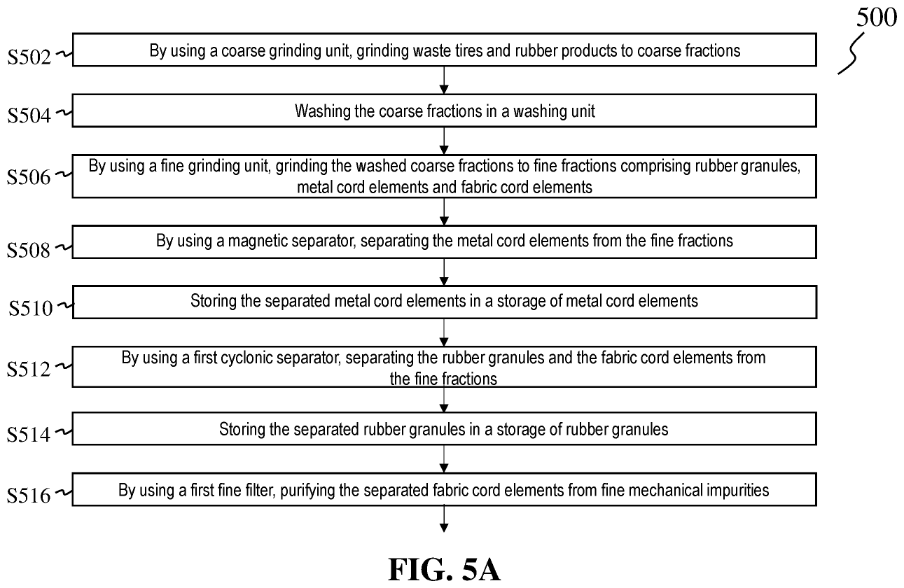

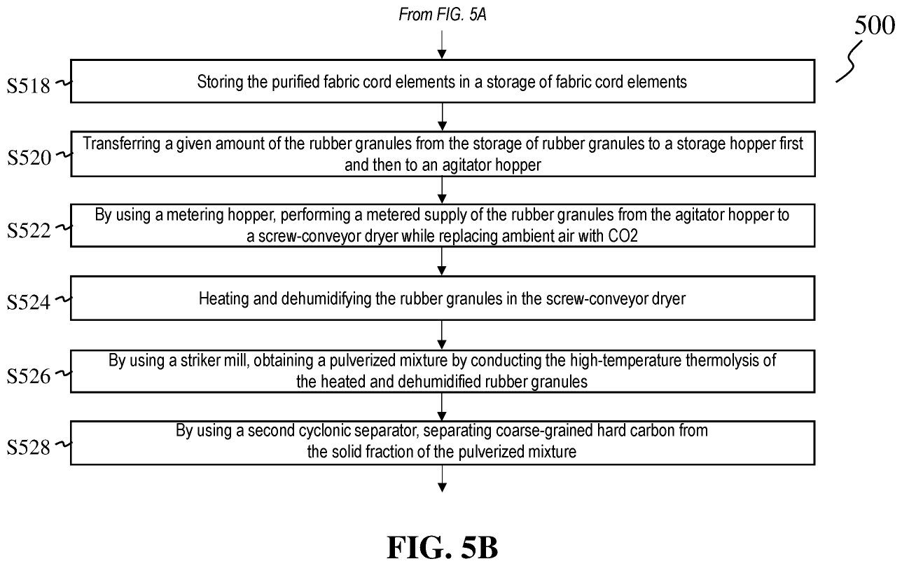

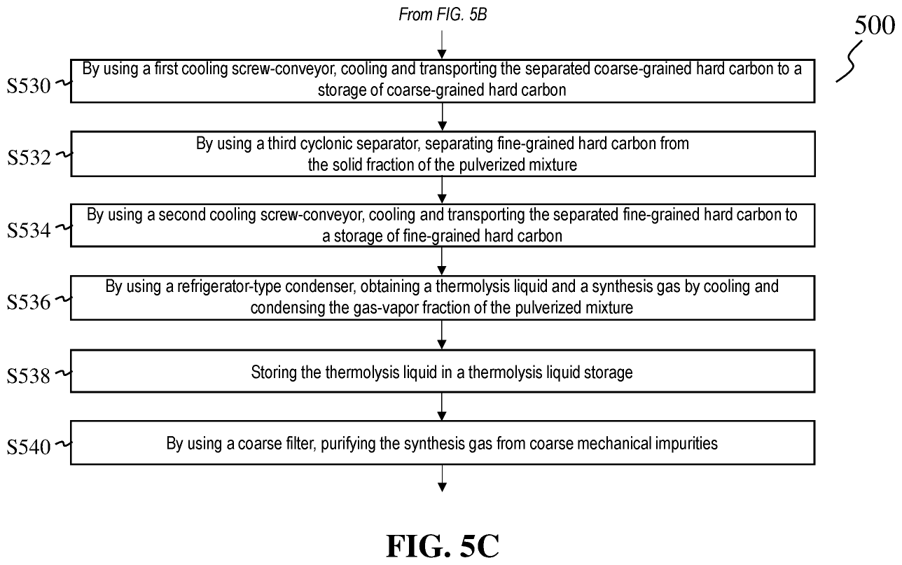

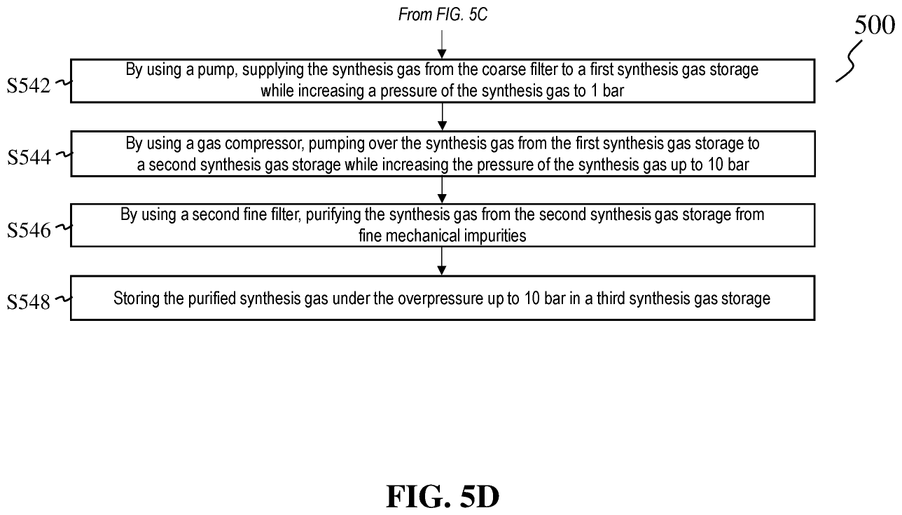

FIGS. 5A-5D show a flowchart of a method 500 for operating the system 100 in accordance with one exemplary embodiment. Thus, each step of the method 500 is performed by the corresponding element of the system 100. The method 500 starts with a step S502, in which the coarse grinding unit 104 grinds the waste tires and rubber products coming from the storage 102 to coarse fractions. Then, the method 500 proceeds to a step S504, in which the coarse fractions are washed in the washing unit 106 and stored in the storage 108. Next, the method 500 goes on to a step S506, in which the fine grinding unit 110 grinds the washed coarse fractions from the storage 108 to fine fractions. As noted earlier, the fine fractions may comprise rubber granules, metal cord elements and fabric cord elements. After that, the method 500 proceeds to a step S508, in which the magnetic separator 112 is used to separate the metal cord elements from the fine fractions. The method 500 further goes on to a step S510, in which the separated metal cord elements are stored in the storage 114. Subsequently, the method 500 proceeds to a step S512, in which the first cyclonic separator 116 is used to separate the rubber granules and the fabric cord elements from the fine fractions, whereafter the separated rubber granules are stored in the storage 118 in a next step S514. Further, the method 500 goes on to a step S516, in which the first fine filter 120 purifies the separated fabric cord elements from fine mechanical impurities, whereafter the purified fabric cord elements are stored in the storage 122 in a next step S518. The method then proceeds to a step S520, in which a given amount of the rubber granules is transferred from the storage 118 to the storage hopper 124 first and then to the agitator hopper 126. After that, the method 500 goes on to a step S522, in which the metering hopper 128 performs a metered supply of the rubber granules from the agitator hopper 126 to the screw-conveyor dryer 130, while replacing ambient air with carbon dioxide (CO2). Next, the method 500 proceeds to a step S524, in which the rubber granules are heated and dehumidified in the screw-conveyor dryer 130. Then, the method 500 goes on to a step S526, in which a pulverized mixture is obtained by conducting the high-temperature thermolysis of the heated and dehumidified rubber granules in the striker mill 132. As noted earlier, the pulverized mixture comprises a solid fraction and a gas-vapor fraction. The solid fraction comprises coarse-grained hard carbon and fine-grained hard carbon. The method 500 further proceeds to steps S528 and S530, in which the second cyclonic separator 134 is used to separate the coarse-grained hard carbon from the solid fraction of the pulverized mixture and the first cooling screw-conveyor 136 is used to cool and transport the separated coarse-grained hard carbon to the storage 138. After that, the method 500 goes on to steps S532 and S534, in which the third cyclonic separator 140 is used to separate the fine-grained hard carbon from the solid fraction of the pulverized mixture and the second cooling screw-conveyor 142 is used to cool and transport the separated fine-grained hard carbon to the storage 144. Next, the method 500 proceeds to steps S536 and S538, in which a thermolysis liquid and a synthesis gas are obtained by cooling and condensing the gas-vapor fraction of the pulverized mixture in the refrigerator-type condenser 146 and the thermolysis liquid is stored in the storage 148. Further, the method 500 goes on to steps S540 and S542, in which the coarse filter 150 is used to purify the synthesis gas from coarse mechanical impurities and the pump 152 is used to supply the synthesis gas from the coarse filter 150 to the first synthesis gas storage 154, while increasing the pressure of the synthesis gas to 1 bar. Then, the method 500 proceeds to a step S544, in which the gas compressor 156 is used to pump over the synthesis gas from the first synthesis gas storage 154 to the second synthesis gas storage 158, while increasing the pressure of the synthesis gas up to 10 bar. After that, the method 500 goes on to steps S546 and S548, in which the second fine filter 160 is used to purify the synthesis gas from the second synthesis gas storage 158 from fine mechanical impurities and the purified synthesis gas is stored under the overpressure up to 10 bar in the third synthesis gas storage 162.

### Experiment

To implement the method 500, the constructive elements of the system 100 were arranged in the order shown in FIG. 1. Raw materials contained: 1000 kg of waste tires and rubber products.

The method 500 was carried out as follows.

High-temperature thermolysis was carried out in a carbon dioxide (CO2) environment without access to the ambient air, which is necessary to ensure the safety of the process, as well as to exclude oxidative processes between the products resulted from the thermolysis. The thermolysis was carried out at a temperature of 760-810° C. in the striker mill 132 (see FIGS. 1 and 4). The ambient air was displaced and replaced with carbon dioxide with the aid of the metering hopper 128 (see FIGS. 1 and 2). The drying process was carried out by using the screw-conveyor dryer 130 (see FIGS. 1 and 3).

As a result of the experiment, a synthesis gas, carbon black, and a liquid fraction in the form of a thermolysis liquid were obtained.

The gas chromatographic analysis of the synthesis gas obtained by the thermolysis of the rubber granules resulted from the waste tires showed the presence of the following components in the synthesis gas:

| | vol. % | | | | | | | | | | | |
|---|---|---|---|---|---|---|---|---|---|---|---|---|
| | Component name | | | | | | | | | | | |
| | | | | | | Ethane | Propane | C4 | C5 | C6 | | Total |
| | H2 | N2 | CH4 | CO | CO2 | Ethylene | Propylene | sum | sum | sum | H2O | sum |
| 760° C.- | 30.5 | 2.41 | 42.46 | 6.84 | 4.27 | 9.94 | 0.53 | 0.14 | 0.00 | 2.07 | 0.84 | 100.0 |
| 810° C. | | | | | | | | | | | | |

The calorific value of the synthesis gas (by combustible fraction): Qn lower = 29 MJ/m³ or 6903 kcal/m³.

The density of the synthesis gas: P=0.811 kg/m3.

The coarse-grained hard carbon was obtained at the outlet of the second cyclonic separator 134 (implemented as a uniflow cyclone), while the fine-grained hard carbon was obtained at the outlet of the third cyclonic separator 140 (implemented as a group cyclone).

The thermolysis liquid entered the eighth storage 148.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A method for conducting high-temperature thermolysis of waste tires and rubber products, comprising:
by using a coarse grinding unit, grinding the waste tires and the rubber products to coarse fractions;
washing the coarse fractions in a washing unit;
by using a fine grinding unit, grinding the washed coarse fractions to fine fractions, the fine fractions comprising rubber granules, metal cord elements and fabric cord elements;
by using a magnetic separator, separating the metal cord elements from the fine fractions;
storing the separated metal cord elements in a storage of metal cord elements;
by using a first cyclonic separator, separating the rubber granules and the fabric cord elements from the fine fractions;
storing the separated rubber granules in a storage of rubber granules;
by using a first fine filter, purifying the separated fabric cord elements from fine mechanical impurities;
storing the purified fabric cord elements in a storage of fabric cord elements;
transferring a given amount of the rubber granules from the storage of rubber granules to a storage hopper first and then to an agitator hopper;
by using a metering hopper, performing a metered supply of the rubber granules from the agitator hopper to the screw-conveyor dryer while replacing ambient air with carbon dioxide (CO2);
heating and dehumidifying the rubber granules in the screw-conveyor dryer;
by using a striker mill, obtaining a pulverized mixture by conducting the high-temperature thermolysis of the heated and dehumidified rubber granules, the pulverized mixture comprising a solid fraction and a gas-vapor fraction, the solid fraction comprising coarse-grained hard carbon and fine-grained hard carbon;
by using a second cyclonic separator, separating the coarse-grained hard carbon from the solid fraction of the pulverized mixture;
by using a first cooling screw-conveyor, cooling and transporting the separated coarse-grained hard carbon to a storage of coarse-grained hard carbon;
by using a third cyclonic separator, separating the fine-grained hard carbon from the solid fraction of the pulverized mixture;
by using a second cooling screw-conveyor, cooling and transporting the separated fine-grained hard carbon to a storage of fine-grained hard carbon;
by using a refrigerator-type condenser, obtaining a thermolysis liquid and a synthesis gas by cooling and condensing the gas-vapor fraction of the pulverized mixture;
storing the thermolysis liquid in a thermolysis liquid storage;
by using a coarse filter, purifying the synthesis gas from coarse mechanical impurities;
by using a pump, supplying the synthesis gas from the coarse filter to a first synthesis gas storage while increasing a pressure of the synthesis gas to 1 bar;
by using a gas compressor, pumping over the synthesis gas from the first synthesis gas storage to a second synthesis gas storage while increasing the pressure of the synthesis gas up to 10 bar;
by using a second fine filter, purifying the synthesis gas from the second synthesis gas storage from fine mechanical impurities; and
storing the purified synthesis gas under the overpressure up to 10 bar in a third synthesis gas storage.

2. The method of claim 1, wherein each of the coarse fractions has a size ranging from 200 to 300 mm, and each of the fine fractions has a size ranging from 1 to 6 mm.

3. The method of claim 1, wherein the rubber granules are heated to a temperature of 300-350° C. and dehumidified to a humidity of 2-3% in the screw-conveyor dryer.

4. The method of claim 1, wherein the high-temperature thermolysis of the heated and dehumidified rubber granules is conducted in the striker mill at a temperature of 760-810° C.

5. The method of claim 1, wherein the separated coarse-grained hard carbon has a grain size ranging from 0.5 to 0.7 mm and is cooled by the first cooling screw-conveyor to a temperature of 20-50° C., and the separated fine-grained hard carbon has a grain size ranging from 0.1 to 0.49 mm and is cooled by the second cooling screw-conveyor to a temperature of 20-50° C.
